(19) United States
(12) Patent Application Publication
(10) Pub. No.: US 2013/0201024 A1
(43) Pub. Date: Aug. 8, 2013

(54) Detector Assembly With Removable Detecting Module

(71) Applicants: Thomas Greenwood, Terra Ceia, FL (US); Jan A. Braam, Bradenton, FL (US); Jeffrey Glenn Van Keuren, Lakewood Ranch, FL (US); Paul Schatz, Bradenton, FL (US)

(72) Inventors: Thomas Greenwood, Terra Ceia, FL (US); Jan A. Braam, Bradenton, FL (US); Jeffrey Glenn Van Keuren, Lakewood Ranch, FL (US); Paul Schatz, Bradenton, FL (US)

(73) Assignee: UTC FIRE & SECURITY CORPORATION, Farmington, CT (US)

(21) Appl. No.: 13/821,059

(22) PCT Filed: Sep. 7, 2010
(86) PCT No.: PCT/US10/47962

§ 371 Date: Mar. 6, 2013

(51) Int. Cl. G08B 17/10

(52) U.S. Cl. CPC G08B 17/10
USPC 340/628

(57) ABSTRACT

A detector assembly includes a base; a detector chamber removably attached to the base; a detecting module removably secured between the base and the detector chamber, the detecting module including: a detecting module printed circuit board; a sensor mounted to the printed circuit board; a controller mounted on the printed circuit board, the controller generating alarm signal in response to the sensor.

### BACKGROUND OF THE INVENTION

The subject matter disclosed herein relates to a detector assembly and, more particularly, to a detector assembly having a removable detecting module.

Detector assemblies are used to detect a number of hazardous conditions such as smoke, heat and/or carbon monoxide. In certain applications, it is desirable to detect smoke and carbon monoxide. Carbon monoxide detectors are typically packaged as either a stand-alone detector or imbedded in a housing of a smoke detector. If using a stand-alone carbon monoxide detector, the user must purchase two devices (i.e., smoke detector and carbon monoxide detector) thereby increasing the cost as well as the installation effort. A drawback to integrated smoke/carbon monoxide detectors is that the entire unit must be replaced once the service life of the carbon monoxide sensors is reached (approximately 5 years). This is wasteful as the functional smoke detector is discarded along with the carbon monoxide detector.

### BRIEF DESCRIPTION

According to one aspect of the invention a detector assembly includes a base; a detector chamber removably attached to the base; a detecting module removably secured between the base and the detector chamber, the detecting module including: a detecting module printed circuit board; a sensor mounted to the printed circuit board; a controller mounted on the printed circuit board, the controller generating alarm signal in response to the sensor.

According to another aspect of the invention a detector assembly, includes: a base for mounting the detector assembly to a surface; a detector base secured to the base; a detecting module on the detector base for detecting smoke, the detecting module including a light source and a photodetector; a detector chamber removably attached to the detector base; a second detecting module removably secured between the base and the detector chamber, the second detecting module including: a detecting module printed circuit board; a sensor mounted to the printed circuit board; a controller mounted on the printed circuit board, the controller generating alarm signal in response to the sensor; and a cover secured to the detector chamber.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an exploded, perspective view of a detector assembly in an exemplary embodiment;

FIG. 2 is an exploded, perspective view of a detector base and detector chamber of FIG. 1; and

FIG. 3 is an exploded, perspective view of a removable detecting module and the detector base.

The detailed description explains embodiments of the invention, together with advantages and features, by way of example with reference to the drawings.

### DETAILED DESCRIPTION OF THE INVENTION

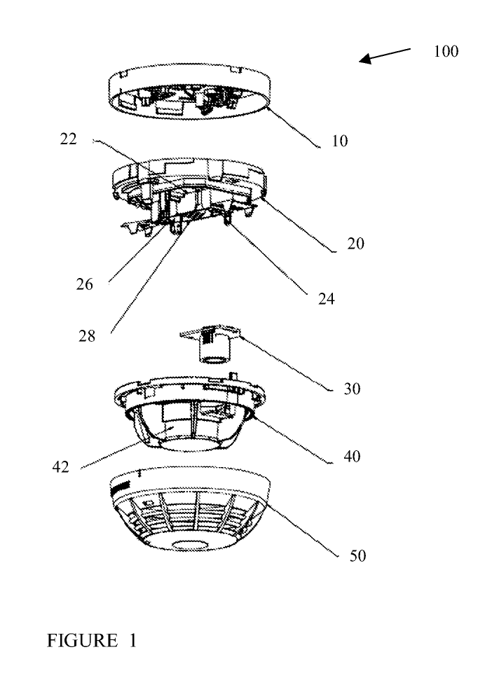

FIG. 1 is an exploded, perspective view of a detector assembly 100 in an exemplary embodiment. Detector assembly 100 includes multiple detecting modules (e.g., smoke and carbon monoxide) and allows for at least one detecting module to be removed for replacement. As shown in FIG. 1, detector assembly 100 includes a mounting base 10. Mounting base 10 includes mounting features (e.g., openings) to allow the detector assembly 100 to be mounted to a surface (e.g., a ceiling or wall) with fasteners.

A detector base 20 houses the detecting modules. It is understood that the detector base 20 and the mounting base 10 may be integrated in a single base. A detector printed circuit board (PCB) 22 is secured to the detector base 20 and includes circuitry and components (e.g., a controller) for performing detection and alarm generation functions. In the embodiment shown in FIG. 1, first and second detecting modules include a smoke detecting module and a carbon monoxide detecting module 30. The smoke detecting module is a light scattering smoke detecting module that includes a light source 24 (e.g., an infrared LED), a light detector 26 (e.g., a photodiode) and an optics box 28.

The second detecting module 30 is a carbon monoxide module. As described in further detail herein with reference to FIG. 3, the carbon monoxide detecting module 30 is a self-contained detecting module including all the components necessary to detect a condition and generate an alarm indication signal.

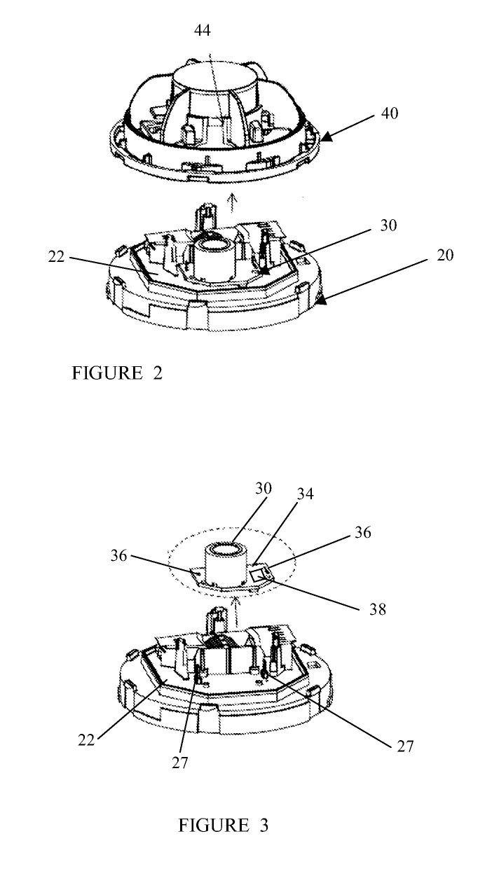

A detector chamber 40 is removably mounted to the detector base 20 via known techniques (e.g., plastic tabs). Detector chamber 40 allows the ambient atmosphere to enter the smoke detecting module. An insect screen 42 prevents insects from entering the smoke detecting module. Detector chamber 40 includes an opening 44 (FIG. 2) for receiving the second detecting module 30. Securing the detector chamber 40 to the detector base 20 holds the second detecting module 30 in position. A cover 50 is removably secured to the mounting base 10 via known techniques (e.g. plastic tabs).

FIG. 2 is an exploded, perspective view of the detector base 20 and detector chamber 40 of FIG. 1. As shown in FIG. 2, the second detecting module 30 is mounted on the detector PCB 22. Second detecting module 30 is received in opening 44 in the detector chamber 40. When detector chamber 40 is secured to detector base 20, second detecting module 30 is held in place between these two components.

FIG. 3 is an exploded, perspective view of second detecting module 30 and the detector base 20. Second detecting module 30 includes a sensor 32 mounted to a detecting module PCB 34. The detecting module PCB 34 includes electrical connections 36 (e.g., plated through holes in PCB 34) to establish electrical connection with connections 27 (e.g., pins) on detector PCB 22. As shown in FIG. 3, pins 27 establish electrical connection with plated through holes 36. Four pins are shown in FIG. 3, with two pins providing power and two pins used for communications (e.g., transmit and receive) between controller 38 and a controller on detector PCB 22.

Second detecting module 30 includes a controller 38 (e.g., a microprocessor) on detecting module PCB 34. Controller 38 monitors the output from sensor 32 (e.g., carbon monoxide sensor) and determines if an alarm condition is present. Controller 38 also includes calibration data for the sensor 32. Controller 38 generates an alarm signal in response to sensor 32 that is transmitted to a controller on detector PCB 22. Accordingly, second detecting module 30 is a self-contained unit, include alarm generation functions. The second detecting module 30 can be removed a replaced by separating the detector chamber 40 from the detector base 20.

Embodiments of the invention allow a detecting module to be replaced when the detecting module has malfunctioned or reached the end of its service life. Removal of second detecting module 30 does not require replacement of the first detecting module. Further, the modular nature of the second detecting module (e.g., self contained alarm generation, calibration, etc.) allows a different type of detecting module to be incorporated into the hazard detector 100 to detect different gases or conditions. For example, a carbon monoxide detecting module may replaced with a heat detecting module depending on the application.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A detector assembly, comprising:
a base;
a detector chamber removably attached to the base;
a detecting module removably secured between the base and the detector chamber, the detecting module including:
a detecting module printed circuit board;
a sensor mounted to the printed circuit board;
a controller mounted on the printed circuit board, the controller generating alarm signal in response to the sensor.

2. The detector assembly according to claim 1 further comprising:
a second detecting module.

3. The detector assembly according to claim 1 further comprising:
a detector printed circuit board, the detecting module printed circuit board having a electrical connection with the detector printed circuit board.

4. The detector assembly according to claim 3 wherein:
the detecting module printed circuit board includes plated through holes;
the detector printed circuit board includes pins for making an electrical connection with the plated through holes.

5. The detector assembly according to claim 4 wherein:
two pins provide power to the detecting module and two pins provide communications for the detecting module.

6. The detector assembly according to claim 1 wherein:
the controller includes calibration data for the sensor.

7. The detector assembly according to claim 1 wherein:
the detecting module detects carbon monoxide.

8. The detector assembly according to claim 2 wherein:
the second detecting module detects smoke.

9. A detector assembly, comprising:
a base for mounting the detector assembly to a surface;
a detector base secured to the base;
a detecting module on the detector base for detecting smoke, the detecting module including a light source and a photodetector;
a detector chamber removably attached to the detector base;
a second detecting module removably secured between the base and the detector chamber, the second detecting module including:
a detecting module printed circuit board;
a sensor mounted to the printed circuit board;
a controller mounted on the printed circuit board, the controller generating alarm signal in response to the sensor; and
a cover secured to the detector chamber.
